(19) United States
(12) Patent Application Publication
(10) Pub. No.: US 2021/0388702 A1
(43) Pub. Date: Dec. 16, 2021

(54) Method of Stimulating Hydrocarbon Production

(71) Applicant: Equinor Energy AS, Stavanger (NO)

(72) Inventor: Alexander Rozhko, Sandnes (NO)

(21) Appl. No.: 17/287,369

(22) PCT Filed: Oct. 15, 2019
(86) PCT No.: PCT/NO2019/050220

§ 371 Date: Apr. 21, 2021

(30) Foreign Application Priority Data
Oct. 22, 2018 (GB) 1817163.7

(51) Int. Cl. E21B 43/25

(52) U.S. Cl. CPC E21B 43/25

(57) ABSTRACT

A method is presented for predicting which shape and/or amplitude of seismic wave or wave pulse would cause an increase in oil relative permeability when a seismic wave or wave pulse with that shape and/or amplitude is applied to a region of interest. The method comprises: (a) obtaining one or more parameter values for the region of interest; (b) inputting the one or more parameter values into a model which predicts changes in oil relative permeability for the region of interest for different seismic wave or wave pulse shapes and/or amplitudes; (c) repeating step (b) one or more times for different seismic wave or wave pulse shapes and/or amplitudes; and (d) determining which seismic wave or wave pulse shape and/or amplitude causes an increase or the greatest increase in oil relative permeability based on the output of the model.

The present invention relates to the field of hydrocarbon production. In particular, it relates to a method for predicting which shape of seismic wave or wave pulse would cause an increase in oil relative permeability (and/or decrease in water relative permeability) when a seismic wave or wave pulse with that shape is applied to a region of interest, and a method of and apparatus for stimulating hydrocarbon production using that method.

During the last 60 years, it has been observed that stimulation from low-frequency seismic waves generated from earthquakes and cultural noise may alter water and oil production from subsurface regions (e.g. wells or reservoirs).

In some cases, it has been seen (Beresnev and Johnson, 1994; Manga et al., 2012) that:

1) small transient strains as low as 10⁻⁶ could significantly increase the permeability and, hence, mobility of fluids;

2) upon stopping the dynamic stimulation, the mobility of fluids recovers to pre-stimulated value; and

3) a few cycles of oscillations are sufficient to change the fluid mobility.

However, the mechanisms that can cause these changes in permeabilities (and hence changes in fluid mobility) at such small stresses remained unclear. Dynamic stresses during seismic wave propagation are very small (<1 bar), too small to cause the permeability alteration by shear failure or tensile fracturing. Furthermore, the permeability alteration cannot be explained by pressure-dependent permeability effects, which require much greater stress variations.

Previous models for describing this effect can be divided to two classes of processes that can explain how small changes in stress could change permeability (Beresnev and Johnson, 1994; Manga et al., 2012):
(i) mobilisation of colloidal deposits; and
(ii) mobilisation of pore-blocking non-wetting bubbles or droplets.
   However, these models cannot answer two simple questions:
(i) Will the oil relative permeability increase or decrease?
(ii) How does the oil relative permeability change depend on the wave amplitude and/or shape?

As a result of the inability to predict whether oil relative permeability (and hence oil mobility or flow) would increase or decrease as a result of stimulation from a seismic wave, the oil industry has been reluctant to adopt technologies for stimulating oil production with seismic waves.

A first aspect of the invention relates to a method of predicting which shape and/or amplitude of seismic wave or wave pulse would cause an increase in oil relative permeability (and/or decrease in water relative permeability) when a seismic wave or wave pulse with that shape and/or amplitude is applied to a region of interest, the method comprising:

(a) obtaining one or more parameter values for the region of interest;

(b) inputting the one or more parameter values into a model which predicts changes in oil (and/or water) relative permeability for the region of interest for different seismic wave or wave pulse shapes and/or amplitudes;

(c) repeating step b one or more times for different seismic wave or wave pulse shapes and/or amplitudes; and

(d) determining which seismic wave or wave pulse shape and/or amplitude would cause an increase, or the greatest increase, in oil relative permeability (and/or a decrease, or the greatest decrease, in water relative permeability) based on (e.g. solely or at least partially based on) the output of the model.

Thus, a region of interest may be modelled, e.g. based on its rock and/or fluid properties, to determine which shape and/or amplitude of seismic wave or wave pulse, when applied to that region of interest, would cause an increase or the greatest increase in oil relative permeability (and/or a decrease, or the greatest decrease, in water relative permeability).

The aim of the method is to predict which shape and/or amplitude of seismic wave or wave pulse, when applied to that region of interest, would cause an increase or the greatest increase in oil relative permeability, as applying a seismic wave or wave pulse with this shape and/or amplitude would then result in an increase in oil flow and oil production.

However, increases in oil relative permeability generally occur with associated decreases in water relative permeability, and vice versa.

Therefore, e.g. rather than determining which seismic wave or wave pulse shape and/or amplitude would cause an increase, or the greatest increase, in oil relative permeability, the method could comprise determining which seismic wave or wave pulse shape and/or amplitude would cause a decrease, or the greatest decrease, in water relative permeability, as this would likely also be associated with an increase in oil relative permeability.

However, there may be instances where only one of the oil or water relative permeabilities changes. Thus, the method preferably comprises determining which shape and/or amplitude of seismic wave or wave pulse can cause an increase or the greatest increase in oil relative permeability (as opposed to a decrease or the greatest decrease in water relative permeability), as this can provide the most accurate prediction for stimulating oil production.

In the description below, references to an increase or the greatest increase in oil relative permeability may be replaced with references to a decrease or the greatest decrease in water relative permeability.

Some shapes of seismic wave or wave pulse may cause a decrease in oil relative permeability for a particular region of interest, depending, for example, on its rock and fluid properties. In some cases, only one tested wave or wave pulse shape and/or amplitude may cause an increase in oil relative permeability, in which case that wave or wave pulse shape and/or amplitude could be selected. In other cases, more than one tested wave or wave pulse shape and/or amplitude may cause an increase in oil relative permeability, in which case the wave or wave pulse shape which causes the greatest increase in oil relative permeability may be selected.

By determining which shape and/or amplitude of seismic wave or wave pulse will cause an increase or the greatest increase in oil relative permeability, this can allow oil relative permeability, and hence oil flow, to be increased by applying a seismic wave or wave pulse with that shape and/or amplitude to the region of interest. This is in contrast to prior art efforts, in which it has not been known how to determine the shape and/or amplitude of seismic wave or wave pulse which will cause an increase or the greatest increase in oil relative permeability for a particular region of interest, and so the shape and/or amplitude of seismic wave or wave pulse which would cause an increase or the greatest increase in oil relative permeability for a particular region of interest could not been determined.

Determining which shape and/or amplitude of seismic wave or wave pulse can cause the greatest increase in oil relative permeability can then allow the most effective shape and/or amplitude of seismic wave or wave pulse to be applied to the region of interest, to increase oil relative permeability, increase oil mobility and oil flow, decrease water relative permeability and thereby stimulate hydrocarbon production with a higher oil-water ratio. Higher oil-water ratios are advantageous as they enhance the oil recovery from the reservoir.

The relative permeability for each phase (e.g. oil or water) may be determined by dividing the effective permeability to flow (of the oil or water phase) by the absolute permeability. Thus, the oil (water) relative permeability is the oil (water) effective permeability to flow divided by the absolute permeability.

The region of interest could be any subsurface region producing hydrocarbons. The region would preferably have a low oil/water ratio.

For example, the method could be used in regions where traditional oil recovery methods are used, e.g. to supplement and improve oil recovery in these regions. Three traditional methods of oil recovery which could be supplemented by use of the present invention are: primary, secondary and tertiary oil recovery methods. Primary oil recovery refers to the process of extracting oil either via the natural rise of hydrocarbons to the surface of the Earth or via pump jacks and other artificial lift devices. Secondary oil recovery involves the injection of gas or water, which will displace the oil, force it to move from its resting place and bring it to the surface. Tertiary oil recovery includes injection of chemicals to reduce the surface tension and capillary trapping effects of oil bulbs. High temperature steam or water could also be injected in tertiary oil recovery. Hydrocarbon recovery in any of these methods could be improved by using the present invention.

In order to model the region of interest and determine which seismic wave or wave pulse shape and/or amplitude would be most effective for increasing oil relative permeability (and/or decreasing water relative permeability), one or more parameter values for the region of interest are obtained. These parameter values preferably relate to the physical (e.g. rock) and/or fluid properties of the particular region of interest, and can allow, for example, the physical and/or fluid properties of the particular region of interest to be modelled.

The parameter values may comprise one or more of: the Young's modulus, Poisson's ratio, crack length, initial crack aspect ratio, Skempton's coefficients for oil and/or water phases, oil-water interface tension, advancing and receding contact angles (or wettability, which is defined by advancing and receding contact angles), and minimum effective stress. Further parameter values may additionally or alternatively be used, if desirable, e.g. for a particular region.

The parameter values preferably comprise advancing and receding contact angles, or wettability, which is defined by the advancing and receding contact angles. These values (advancing and receding contact angles or wettability) are particularly important because the wettability determines the polarity of a wave pulse (e.g. compressional or extensional) which should be applied to the region of interest to increase oil relative permeability.

Other parameters may determine the relative amplitude of a seismic wave or wave pulse which should be applied.

The parameter values preferably comprise the oil and water Skempton's coefficients. This is because it has been found that the shape of a wave pulse (to be applied to a region in order to increase oil relative permeability) depends on the ratio of oil and water Skempton's coefficients. However, the Skempton's coefficient for water is usually higher than Skempton's coefficient for oil because oil is more compressible.

The parameter values may change (e.g. for a particular region of interest). For example, parameter values may change during chemical flooding and thermal heating of the region of interest. In particular, surface tension and contact angles can be affected by chemicals and heating. Skempton's coefficients can also change during changes of oil and water saturation. As such, the method may be repeated with different parameter values, e.g. if/when/as one or more of the parameter values change(s).

In some embodiments, step (a) may comprise measuring one or more of the required parameter values. Such measurements may be made directly from the region of interest and/or they may be made in a laboratory, e.g. from rock samples taken from the region of interest.

In other embodiments, step (a) may comprise obtaining the required parameter values from, for example, a database or other record of the parameter values.

In some embodiments, one or more parameter values may be measured and one or more may be obtained from a database or other record.

Some parameter values may be determined (e.g. calculated or estimated) from other parameter values (e.g. further parameter values which may not have been referred to above).

Step (b) comprises inputting the one or more parameter values into a model which predicts changes in oil relative permeability (and/or water relative permeability) for the region of interest for different seismic wave or wave pulse shapes and/or amplitudes.

For example, the model may comprise a software model which is arranged to take the one or more parameter values as input, and to ouput (e.g. after determining) a change in oil relative permeability (and/or water relative permeability) for the region of interest for different seismic wave or wave pulse shapes and/or amplitudes, based on (e.g. solely or at least partially based on) the input one or more parameter values.

Preferably, the model is a dual porosity model, e.g. comprising a matrix of (e.g. stiff) pores with (e.g. compliant) cracks located at positions within the matrix of pores.

Preferably, the model is based on (e.g. solely or at least partially based on) wave-induced two-phase fluid-flow (WITPFF), for example between compliant pores (cracks) and stiff pores (matrix)), and/or the contact angle hysteresis effect, and particularly preferably both. Using a model based on (e.g. solely or at least partially based on) WITPFF and the contact angle hysteresis effect can allow changes in oil (and water) relative permeability for the region of interest for different seismic wave or wave pulse shapes and/or amplitudes to be predicted.

A model based on (e.g. solely or at least partially based on) WITPFF and/or the contact angle hysteresis effect means that the model involves modelling or making calculations about the WITPFF and/or the contact angle hysteresis effect in the region of interest.

The model is preferably based on (e.g. solely or at least partially based on) WITPFF and/or the contact angle hysteresis effect because it has been found that these two mechanisms lead to a significant change in crack saturation (in the region of interest) during WITPFF, and changes in crack saturation affect the relative permeabilities of the crack.

In has been found that together, the above two effects or mechanisms work like a semi-permeable membrane for the oil and water phases during wave-induced two-phase fluid-flow caused by crack deformation (e.g. the narrowing or widening of cracks).

In step (b), the region of interest is preferably modelled as a matrix of stiff pores with compliant cracks located at positions within the matrix of stiff pores. The cracks may be considered as imperfectly bonded grain (pore) contacts. Preferably, in the model, the cracks and the matrix of stiff pores are connected in three dimensions.

It is understood that WITPFF is brought about by adjacent pores and cracks having different compliances. Stimulation of the matrix with a seismic wave or wave pulse can cause narrowing or widening of the cracks (wave-induced crack deformation), thereby affecting crack saturation and relative permeabilities of the crack, and inducing two-phase fluid flow between the cracks and the matrix.

The method comprises using different seismic wave or wave pulse shapes and/or amplitudes, and determining which seismic wave or wave pulse shape and/or amplitude will cause an increase, or the greatest increase, in oil relative permeability (or a decrease, or the greatest decrease, in water relative permeability).

A seismic wave may be or comprise a continuous or sinusoidal wave, for example.

A seismic wave pulse is, for example, a special non-periodic waveform. A seismic wave pulse may have one major crest. In some cases, the major crest may be accompanied by one or more minor or sub-harmonic crests. Such a wave pulse may be referred to as a wave packet or wavelet.

The seismic wave or wave pulse shapes and/or amplitudes input into the model may comprise two or more seismic wave or wave pulse shapes and/or amplitudes (e.g. two or more different shapes and two or more different amplitudes).

A wave pulse may comprise a crest of a particular amplitude and polarity. Such wave pulses may cause local compressional or extensional stress perturbations, e.g. depending on the polarity of the wave pulse.

Seismic wave or wave pulse shapes may be defined by their frequency or frequencies, polarity (e.g. positive/negative, or compressional/extensional), duration (e.g. for a wave pulse) and/or number and/or (relative) amplitude of crests (e.g. in a wavelet), for example.

Some of these parameters, such as frequency, or frequency range, in particular, may be dependent on the seismic source (e.g. the type of seismic source) that would be used to emit the seismic waves or wave pulses. For example, it may not be possible to vary a frequency range in practice, e.g. for a given type of seismic source.

On the other hand, it may be possible to vary other parameters (e.g. for a given type of seismic source), such as, and preferably, polarity and/or amplitude and/or shapes (defined by frequency spectrum within the frequency range). If several seismic sources are used, it may be possible to define the location of seismic sources and/or the time shift between seismic sources, which could produce a focused vibration pulse at the region of interest.

The method preferably comprises determining

The method (e.g. at step (d) preferably comprises determining both which seismic wave or wave pulse shape and which seismic wave or wave pulse amplitude would cause an increase, or the greatest increase, in oil relative permeability (and/or a decrease, or the greatest decrease, in water relative permeability).

Thus, step (b) preferably comprises inputting the one or more parameter values into a model which predicts changes in oil (and/or water) relative permeability for the region of interest for different seismic wave or wave pulse shapes and amplitudes.

Step (c) preferably comprises repeating step (b) one or more times for different seismic wave or wave pulse wavelet shapes and amplitudes.

Thus, the method preferably comprises determining both which seismic wave or wave pulse shape and which seismic wave or wave pulse amplitude should be used to stimulation hydrocarbon production.

Step (d) may comprise determining which amplitude of seismic wave or wave pulse shape would cause an increase or the greatest increase in oil relative permeability (or a decrease, or the greatest decrease, in water relative permeability) based on (e.g. solely or at least partially based on) the output of the model.

In a preferred embodiment, step (d) comprises determining a minimum seismic wave or wave pulse amplitude which would cause a non-negligible increase in oil relative permeability (and/or a non-negligible decrease in water relative permeability) based on (e.g. solely or at least partially based on) the output of the model.

In a preferred embodiment, step (b) comprises first determining which shape (e.g. polarity) of seismic wave or wave pulse would cause an increase or the greatest increase in oil relative permeability (and/or a decrease, or the greatest decrease, in water relative permeability) based on (e.g. solely or at least partially based on) the output of the model, and then determining either:
(i) which amplitude of seismic wave or wave pulse (e.g. with the determined shape or polarity) would cause an increase or the greatest increase in oil relative permeability (and/or a decrease, or the greatest decrease, in water relative permeability) based on (e.g. solely or at least partially based on) the output of the model or;
(ii) (preferably) a minimum seismic wave or wave pulse amplitude which would cause a non-negligible increase in oil relative permeability (and/or a non-negligible decrease in water relative permeability) based on (e.g. solely or at least partially based on) the output of the model.

A non-negligible increase in oil relative permeability may or would occur when the contact line between oil and water in a partially-saturated crack is de-pinned, De-pinning of the contact line leads to large changes in crack saturation and thus leads to large changes in crack relative permeabilities. When the contact line is pinned, changes in crack saturation are negligibly small and thus changes in relative permeabilities are also small. The minimum wave pulse amplitude may be defined as the wave pulse amplitude at or above which the contact line is de-pinned.

The seismic wave or wave pulse shapes used in the method preferably comprise seismic waves or wave pulses with varying polarity.

The different seismic wave or wave pulse shapes input into the model preferably comprise wave pulse shapes. This is because it has been found that stimulating a region of interest with wave pulses, as opposed to continuous (sinusoidal) seismic waves, leads to a greater increase in oil relative permeability (and/or decrease in water relative permeability), e.g. for the same amplitude.

It has been found that, depending on the particular rock and fluid properties of the region of interest applying a seismic wave pulse with positive or negative polarity may result in either an increase or a decrease in oil relative permeability. Thus, the polarity of the seismic wave pulse which will cause an increase in oil relative permeability (and/or a decrease in water relative permeability) is preferably determined for the particular region of interest.

The wave pulse shapes (used in the method) preferably comprise at least two wave pulse shapes, the at least two wave pulse shapes preferably having opposite (or varying) polarities and/or varying amplitudes. Preferably, the wave pulse shapes comprise wave pulse shapes with different polarities and different amplitudes.

Thus, step (d) preferably comprises determining which polarity wave pulse shape would cause an increase or the greatest increase in oil relative permeability (and/or a decrease, or the greatest decrease, in water relative permeability) based on (e.g. solely or at least partially based on) the output of the model.

Additionally, or alternatively, step (d) may comprise determining which amplitude of wave pulse shape would cause an increase or the greatest increase in oil relative permeability (and/or a decrease, or the greatest decrease, in water relative permeability) based on (e.g. solely or at least partially based on) the output of the model.

In a preferred embodiment, step (d) comprises determining a minimum wave pulse amplitude which would cause a non-negligible increase in oil relative permeability (and/or a non-negligible decrease in water relative permeability) based on (e.g. solely or at least partially based on) the output of the model

In a preferred embodiment, step (b) comprises first determining which polarity wave pulse would cause an increase or the greatest increase in oil relative permeability (and/or a decrease, or the greatest decrease, in water relative permeability) based on (e.g. solely or at least partially based on) the output of the model, and then determining either:
(i) which amplitude of wave pulse (e.g. with the determined polarity) would cause an increase or the greatest increase in oil relative permeability (and/or a decrease, or the greatest decrease, in water relative permeability) based on (e.g. solely or at least partially based on) the output of the model; or
(ii) (preferably) a minimum wave pulse amplitude which would cause a non-negligible increase in oil relative permeability (and/or a non-negligible decrease in water relative permeability) based on (e.g. solely or at least partially based on) the output of the model.

A non-negligible increase in oil relative permeability is described above.

The method is preferably performed on a computer (or computers). Preferably, the result of the method, e.g. the determined shape and/or amplitude (preferably both) of seismic wave or wave pulse, is displayed on a screen. For example, one or more parameters (e.g. polarity and/or amplitude) defining the determined wave or wave pulse shape and/or amplitude may be displayed, e.g. numerically. Alternatively or additionally, the determined shape and/or amplitude of seismic wave or wave pulse may be displayed graphically, e.g. on a graph. In any case, the predicted increase in oil relative permeability may also be displayed.

According to a second aspect, there is provided a method of stimulating hydrocarbon production comprising:

(a) predicting which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest; and

(b) applying a seismic wave or wave pulse with the predicted shape and/or amplitude to the region of interest, thereby stimulating hydrocarbon production.

Thus, hydrocarbon production from a region of interest may be effectively stimulated by first determining which shape and/or amplitude of seismic wave or wave pulse will cause an increase or the greatest increase in oil relative permeability (and/or a decrease, or the greatest decrease, in water relative permeability) and then applying a seismic wave or wave pulse (preferably a plurality of seismic wave pulses) with that shape and/or amplitude to the region of interest.

The method preferably further comprises also recovering hydrocarbons from the region of interest, e.g. in a conventional way such as one of the primary, secondary or tertiary methods described above.

Preferably, step (b) is performed while and/or for as long as hydrocarbon recovery is performed from the region of interest.

Step (a) may comprise determining, for example using a model such as a software model, e.g. as described above, which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest. This is preferably based on (e.g. solely or at least partially based on) one or more parameter values for the region of interest. Such one or more parameter values may be used as input for the model to determine or predict which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest.

In this second aspect of the invention, step (a) preferably comprises performing the method of the first aspect of the invention described above (e.g. with any of its optional or preferred features), in order to predict which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to the region of interest.

Step (b) preferably comprises applying the seismic wave or wave pulse with the predicted shape and/or amplitude to the region of interest with a seismic source (or a plurality of seismic sources). The seismic source(s) may be as described below, for example.

The seismic wave or wave pulse is preferably a seismic wave pulse. Thus, preferably, a plurality or stream or series of wave pulses with the predicted shape and/or amplitude is applied to the region of interest.

There may be a time gap between consecutive wave pulses. The time gap may be, for example, three to five times the duration of the (individual) pulses. Larger or smaller time gaps could alternatively be used, depending, for example, on how long it takes for the region of interest to return to its equilibrium state (most-stable equilibrium state) after a seismic wave pulse has been applied. The time gap between successive wave pulses is thus preferably determined based on (e.g. solely or at least partially based on) how long it takes for the region of interest to return to its equilibrium state (most-stable equilibrium state) after a seismic wave pulse (with the determined shape and/or amplitude) has been applied.

According to a third aspect, there is provided a method of stimulating hydrocarbon production comprising applying a seismic wave pulse to a region of interest to increase oil relative permeability (and/or decrease water relative permeability) for the region of interest and thereby stimulate hydrocarbon production.

Thus, as described above, for example, seismic wave pulses, e.g. with either positive or negative polarity (e.g. as determined according to the first aspect), may be applied to a region of interest, thereby increasing oil relative permeability (and/or decreasing water permeability) for that region of interest and stimulating hydrocarbon production due to increased oil mobility.

Such a method preferably comprises performing the method of the first aspect (for example with any or all of its preferred or optional features) in order to determine what shape (e.g. positive or negative polarity) and/or amplitude (or minimum amplitude) the seismic wave pulse should have in order to result in an increase in oil relative permeability (and/or decrease in water permeability). This is because, depending on the particular rock and fluid properties of the region of interest applying a seismic wave pulse with positive or negative polarity may result in either an increase or a decrease in oil relative permeability.

Applying a seismic wave pulse to a region of interest preferably comprises applying a plurality of the seismic wave pulses to the region of interest. For example, the seismic wave pulse may be applied continuously, e.g. a stream of seismic wave pulses may be applied. It has been found that an increase in oil relative permeability may occur after a few wave pulses (e.g. of a determined polarity (positive or negative) and/or sufficient amplitude) have been applied. Thus, a few cycles of wave pulses may be sufficient to increase oil relative permeability (and hence oil/water ratio) in producing wells. It should be kept in mind that this effect would be observed at the surface with a time delay (from the initiation of the application of the seismic wave pulses). This is because it takes a certain amount of time for fluids to flow into the borehole, and from borehole to the surface where the produced fluids can be analysed to observe the effect (increase in oil/water ratio).

Thus, the method may further comprise recovering hydrocarbons from the region of interest. For example, during and/or after the stimulation of hydrocarbon production (by applying the seismic wave pulse to the region of interest), hydrocarbons may be recovered or extracted from the region of interest, e.g. in a conventional way.

It is preferred that hydrocarbons are recovered from the region of interest during and/or soon after the stimulation of hydrocarbon production (i.e. the application of the seismic wave pulse). This is because the effect(s) of the stimulation of hydrocarbon production (by applying the seismic wave pulse to the region of interest), e.g. the increase in oil relative permeability, may decrease over time after the stimulation of hydrocarbon production is ceased. Thus, for example, it is preferred that hydrocarbon recovery is performed at the same time as the stimulation of hydrocarbon production.

Preferably, the step of applying a seismic wave pulse to a region of interest is performed while/for as long as hydrocarbon recovery is performed.

According to a fourth aspect, there is provided a system for stimulating hydrocarbon production comprising:

at least one seismic source; and

means for predicting which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest;

wherein the system is arranged such that the at least one seismic source can be controlled to emit seismic waves or wave pulses with a shape and/or amplitude determined by the means for predicting which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest.

Thus, in such a system, the at least one seismic source can be controlled to emit a seismic wave or wave pulse with a shape and/or amplitude which will cause an increase or the greatest increase in oil relative permeability (and/or a decrease, or the greatest decrease, in water relative permeability) for a particular region of interest.

In some embodiments, the at least one seismic source could be a vibrational source (e.g. a seismic vibrator), such as a low frequency (e.g. 1-200 Hz) vibrational source. Such sources may be located at the surface, for example.

In other embodiments, the at least one seismic source could be an acoustic source, such as a high frequency (1-100 kHz) acoustic source. Such sources may be located closer to a region of interest (e.g. in a borehole), for example.

In some embodiments, the at least one seismic source could comprise pressure pulsing technology such as a borehole fluid injector, such pressure pulsing technology being arranged to emit seismic wave pulses in the form of fluid pressure pulses. In such embodiments, compressional or extensional wave pulses may be generated, e.g. by pulsing of fluid pressure in the borehole either by fluid pressure increase (build-up) or decrease (drawdown).

In some embodiments, the at least one seismic source could be an array of seismic receivers working in active mode, located for example above the region of interest.

In other embodiments, the at least one seismic source could be array of marine air gun sources, operating above the region of interest.

The at least one seismic source is preferably arranged to direct seismic waves or wave pulses towards the region of interest (e.g. downwardly in the case of sources located above the region of interest or at the surface).

Preferably, the at least one seismic source is controllable such that it can emit seismic waves or wave pulses with different shapes (e.g. different polarities, frequencies, durations, etc.) and/or amplitudes. Preferably, the emitted seismic waves or wave pulses retain their shape and/or amplitude (or substantially retain it) at the region of interest. The shape and/or amplitude may be determined according to the method described above.

Preferably, the at least one seismic source can emit wave pulses. Preferably, the wave pulses can be controlled to have either positive or negative polarity. Preferably, the emitted wave pulses retain their polarity (or substantially retain it) at the region of interest.

The at least one seismic source can preferably emit seismic waves or wave pulses which (still) have sufficient amplitude and/or the required shape (e.g. polarity) at (the depth of) the region of interest.

The at least one seismic source could be located at the surface or it could be located closer to the region of interest, e.g. in a subsurface location. For example, the seismic source or sources could be located in a borehole.

Preferably, the at least one seismic source can be controlled to emit a seismic wave or wave pulse with a particular amplitude. For example, the amplitude may be determined according to the method described above.

In some embodiments, the at least one seismic source may emit seismic waves or wave pulses with stress amplitudes of around 10⁴ to 10² Pa at the depth of the region of interest, which correspond to strain amplitudes of around 10⁻⁸ to 10⁻⁶ for a rock with a Young's modulus of ˜10 GPa.

It has been found that wave pulses require significantly lower amplitudes than the amplitude that would be required for a comparable effect with a continuous (sinusoidal) wave, for example. As such, the seismic waves or wave pulses used in the present invention are preferably wave pulses.

Preferably, the at least one seismic source is arranged to emit seismic wave pulses. The seismic wave pulses may have positive or negative polarity and preferably the at least one seismic source is controllable such that it can be controlled to emit wave pulses with positive or negative polarity (at the depth of the region of interest) depending, for example, on which has been determined to cause an increase or the greatest increase in oil relative permeability (and/or a decrease, or the greatest decrease, in water relative permeability) for the region of interest.

In some embodiments, the system comprises a plurality of seismic sources. These could be all of the same kind or they could comprise two or more different kinds of seismic sources.

The means for predicting which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest may comprise means (e.g. one or more processors) for determining, for example using a model such as a software model, e.g. as described above, which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest. This is preferably based on (e.g. solely or at least partially based on) one or more parameter values for the region of interest. Such one or more parameter values may be used as input for the model to determine or predict which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest.

Preferably, the means for predicting which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest is arranged to perform the method of the first aspect (with any of its optional or preferred features).

For example, the means for predicting which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest may be or comprise one or more processors which are arranged, programmed or may be controlled to predict which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest, e.g. by performing the method of the first aspect (with any of its optional or preferred features).

The system preferably comprises a controller arranged to cause the at least one seismic source to emit a seismic wave or wave pulse with a shape and/or amplitude for increasing oil relative permeability (and/or decreasing water relative permeability) based on (e.g. solely or at least partially based on) an output of the means for predicting which shape and/or amplitude of seismic wave or wave pulse would cause an increase or the greatest increase in oil relative permeability (and/or a decrease, or the greatest decrease, in water relative permeability) when a seismic wave or wave pulse with that shape and/or amplitude is applied to a region of interest.

Aspects of the invention provide a method for stimulating hydrocarbon production. By providing a method of increasing the oil relative permeability and/or decreasing the water relative permeability, and hence the oil flow, the oil/water ratio of the extracted fluids can be increased. Even small increases (e.g. 0.1%) in the recovery rate can have large economic consequences meaning that even a small improvement is still economically worthwhile.

Furthermore, the technology used to implement the method is cheap and environmentally friendly compared, for example, to other techniques. This is because this method of stimulating hydrocarbon production does not require direct interaction with a reservoir, unlike, for example, fraccing.

The various aspects of the invention described above may be combined such that an aspect could comprise any of the optional or preferred features of one or more other aspects of the invention.

Preferred embodiments of the invention will now be described by way of example only and with reference to the accompanying drawings, in which:

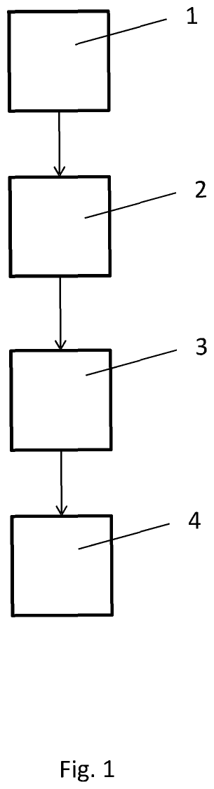

FIG. 1 is a flow diagram illustrating a method of stimulating hydrocarbon production;

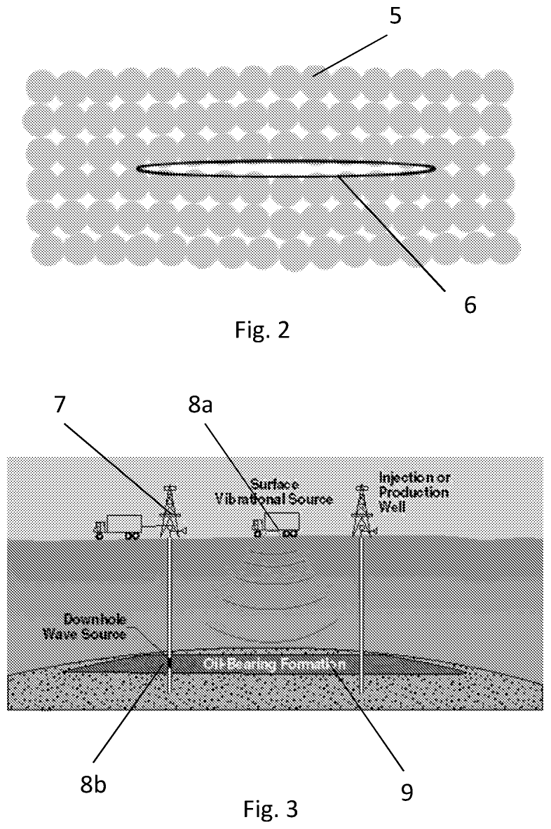

FIG. 2 is a schematic illustration of a dual porosity model;

FIG. 3 is a schematic cross-sectional illustration of apparatus for seismic stimulation of a sub-surface region of interest;

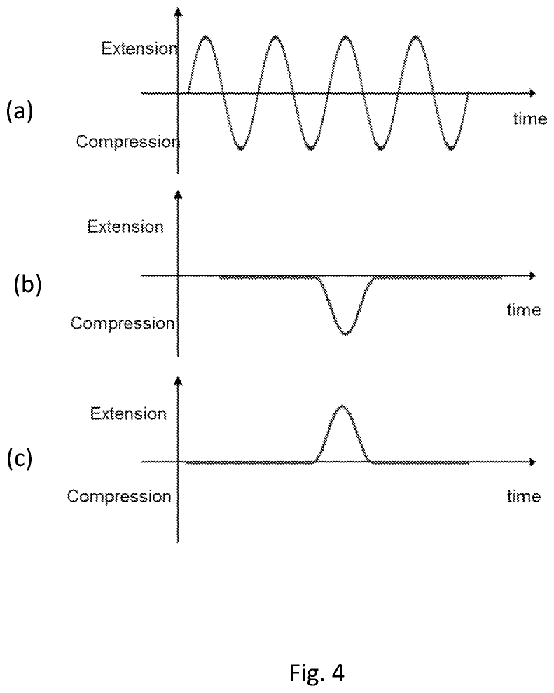

FIGS. 4(a)-(c) are examples of seismic wave or wave pulse shapes; and

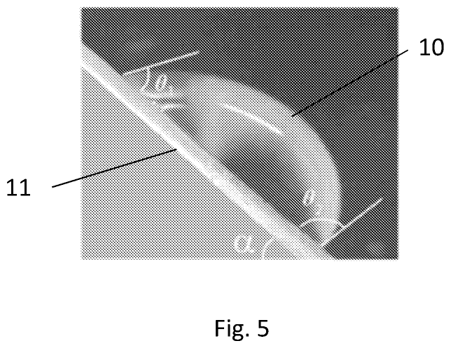

FIG. 5 is a cross-sectional illustration of the contact angle hysteresis effect.

FIG. 1 is a flow diagram illustrating a method of stimulating hydrocarbon production for a particular region of interest.

The method has four main steps: 1, 2, 3 and 4.

At step 1, required parameter values for the region of interest are obtained.

At step 2, the obtained parameter values are input into a model which predicts which wave pulse shape and amplitude for stimulating the region of interest would result in an increase in oil relative permeability.

At step 3, wave pulses with the predicted shape and amplitude for increasing oil relative permeability are applied to the region of interest.

At step 4, hydrocarbons are extracted from the region of interest.

Each of these steps will now be described in more detail.

At step 1, parameter values for the region of interest are obtained.

In some embodiments, step 1 comprises measuring the required parameter values. The measurements may be made directly from the region of interest itself and/or they may be made in a laboratory, e.g. from rock samples taken from the region of interest.

In other embodiments, step 1 comprises obtaining the required parameter values from, for example, a database or other record of the parameter values.

In some embodiments, one or more parameter values are measured and one or more are obtained from a database or other record.

Some parameter values are determined (e.g. calculated or estimated) from other parameter values.

The parameter values comprise values of the Young's modulus, Poisson's ratio, crack length, initial aspect ratio, the Skempton's coefficients for each of oil and water phases, oil-water interface tension, advancing and receding contact angles, and minimum effective in situ stress, for the region of interest

An example of the input parameters used in one case is presented below:
Young's modulus and Poisson's ratio (of rock matrix): 30 GPa and 0.3
Characteristic crack length and initial aspect ratio: 2e⁻³ m and 0.001
The Skempton’ coefficients for oil and water phases: 0.4 and 0.6, respectively
Oil-Water Interface tension: 0.033 Pa*m
Advancing and receding contact angles: 37° and 30°.
Minimum effective stress in the formation: 5 MPa

The initial (most-stable) contact angle is calculated from the advancing and receding contact angles (see, e.g. Ruiz-Cabello, 2014).

At step 2, the parameter values are used in a model to predict which wave pulse shape and amplitude for stimulating the region of interest would result in an increase in oil relative permeability. Specifically, the model calculates the change of relative permeabilities to oil and water in the region of interest for different pulse shapes and amplitudes. The calculated changes in relative permeabilities to oil and water in the region of interest for different pulse shapes are then compared to determine which pulse shape and amplitude provides an increase or the greatest increase in oil relative permeability. This is then selected for use in step 3.

The calculations are performed in the low frequency limit, where capillary forces dominate over viscous forces during WITPFF.

Table 1 (below)) shows an example, of how different input parameters (e.g. characterising different “imaginary” regions of interest) were found, from the model, to affect the sign (direction) of the relative oil permeability (and hence oil mobility) change following the application of compressional and extensional pulses (i.e. seismic wave pulses with opposite polarities). The contact angles are defined (measured) through the water phase. θᵣ is the receding contact angle, θₐ is the advancing contact angle, K_{water} is the Skempton's coefficient for water and Kₒᵢₗ is the Skempton's coefficient for oil.

TABLE 1
Input parameters, sensitive to the sign of relative permeability
change by compressional and extensional pulses.

| | Water wet: 0° < | | Oil-wet: 90° < | |
|---|---|---|---|---|
| | θᵣ < θₐ < 90° | | θᵣ < θₐ < 180° | |
| | K_{water} > Kₒᵢₗ | K_{water} < Kₒᵢₗ | K_{water} > Kₒᵢₗ | K_{water} < Kₒᵢₗ |
| Compressive | Decreased | Increased | Increased | Decreased |
| pulse | Oil mobility | Oil mobility | Oil mobility | Oil mobility |
| Extensive | Increased | Decreased | Decreased | Increased |
| pulse | Oil mobility | Oil mobility | Oil mobility | Oil mobility |

As can be seen from Table 1, for some combinations of input parameters a compressive pulse (wave pulse of a first polarity) was found to cause increased oil mobility, whereas for other (or opposite) combinations of input parameters, an extensive pulse (i.e. a wave pulse of a second, opposite polarity) was found to cause increased oil mobility.

This demonstrates that the polarity of wave pulse required should be determined for each region of interest with its own particular input parameters.

When performing step 2, a representative elementary volume (REV) of the region of interest with a partially saturated crack is considered. A wave pulse signal with a particular shape is applied to the REV and changes in parameters are determined as follows:

The initial parameters are far-field normal stress, fluid pressure in the water or oil phase, initial contact angle and the crack saturation. Application of a seismic wave induces changes to these initial parameters, and causes deformation of the rock and two-phase fluid flow between the matrix and the crack. Non-linear effects, produced by the contact angle hysteresis effects, lead to either an increase or a decrease in oil saturation inside the crack when wave pulses are applied. Changes in the relative permeabilities of the crack are calculated from changes of these parameters using the methodology presented in (Rozhko, 2016; Rozhko and Bauer, 2018). Changes of matrix saturation in the dual porosity model are negligibly small compared to changes of crack saturation. Although crack porosity can be a small fraction of total porosity, the crack permeability can have a significant or dominant impact on the total permeability of the rock. Thus, changes of crack relative permeability affect the overall response of a partially saturated rock to the wave pulse.

Direct measurements of the input parameters may not always be available. In such cases, these parameters are calculated indirectly from other parameters or measurements.

According to Table 1, rock wettability and Skempton's coefficients are the most important input parameters for the model. Other input parameters do not change the polarity of the wave pulse required for an increase in oil relative permeability. Other input parameters change only the amplitude of the oil relative permeability change for a given wave pulse polarity and amplitude.

It may not be always feasible to generate a wave pulse at the depth of the region of interest consisting of only one crest. Several minor crests of different polarities may accompany one major crest. In this case, all input parameters of the model should be considered to determine the resulting effect of such a wave pulse on the oil relative permeability.

The wave pulse shape is the pulse shape of a wave from a seismic source such as a vibrator. A wave pulse is a special non-periodic waveform that typically has one major crest. In some cases, it is accompanied by several minor sub-harmonic crests, in which cases it is called a wave packet.

The wave pulse shape could be compressional, as shown in FIG. 4(b), or extensional, as illustrated in FIG. 4(c). In other words, the wave pulse could have positive or negative polarity. The particular properties (fluid and rock properties) of the region of interest will determine whether a compressional or an extensional wave pulse (i.e. which polarity wave pulse) will cause an increase in oil relative permeability.

The wave pulse will also have an amplitude.

It has been found that a periodic wave, e.g. a sinusoidal wave as shown in FIG. 4(a), is not as effective as a wave pulse at increasing oil relative permeability and stimulating hydrocarbon production.

The model used in step 2 is a dual porosity model based on a combination of two mechanisms:
the wave-induced two-phase fluid flow (WITPFF) between adjacent pores of different compliances; and
the contact angle hysteresis effect.

These two mechanisms lead to a significant change in crack saturation during WITPFF, and changes in crack saturation affect the relative permeabilities of the crack.

Together, the above two effects or mechanisms work like a semi-permeable membrane for the oil and water phases during wave-induced crack deformation (e.g. widening or narrowing).

FIG. 2 is a schematic illustration of a dual porosity model in which the subsurface region of interest is modelled as a matrix of stiff pores 5 with compliant pores or cracks 6 located at positions within the matrix of stiff pores 5. The cracks 6 are imperfectly bonded grain (pore) contacts. The cracks 6 and the matrix of stiff pores 5 are connected in three dimensions.

WITPFF is brought about by adjacent pores 5 and cracks 6 having different compliances. Stimulation of the matrix with a seismic wave can cause the cracks 6 to open or close (wave-induced crack opening or closure), thereby affecting crack saturation and the relative permeabilities of the crack.

The contact angle hysteresis effect is illustrated in FIG. 5. This figure shows a drop of liquid 10 (e.g. oil or water) on an inclined surface 11. The surface 11 has an inclination angle α. As indicated in FIG. 5, the drop 10 has two different contact angles θ₁ and θ₂ to the surface 11 at its upper and lower ends, respectively. At some critical angle, a, the droplet will start to slip. The highest possible contact angle that can be achieved for a given wetting system is called the advancing contact angle, whereas the lowest possible contact angle is called the receding contact angle. The difference between the contact angles θ₁ and θ₂ prevents the drop 10 from sliding down the surface 11. The same mechanism, i.e. contact angle hysteresis, traps oil bubbles inside pores.

At step 2, the model is used to first predict which polarity (e.g. positive or negative, corresponding to extensional or compressional wave pulses, or vice versa) wave pulse will result in an increase in oil relative permeability. The model is then used to determine what is the minimum amplitude required in order to achieve a non-negligible increase in oil relative permeability (for that polarity wave pulse). It has been found that the greater the amplitude, the greater the effect. However, large amplitudes are not always feasible which is why the model is used to predict the minimum amplitude required in order to achieve a non-negligible increase in oil relative permeability.

At step 3, wave pulses with the predicted shape (polarity) and (at least minimum) amplitude for increasing oil relative permeability are applied to the region of interest. Thus, either compressional or extensional wave pulses are applied to the region of interest, with at least the minimum amplitude required for a non-negligible effect, depending on the result of step 2.

The time gap between wave pulses depends on the speed at which the contact angle will equilibrate to its most-stable equilibrium distribution (Ruiz-Cabello, 2014). This is an empirical parameter. At the initial stage the stimulation can be started with a time gap between pulses which is 3 to 5 five times larger than the duration of the pulses.

Step 3 can be performed with different kinds of seismic sources. For example, seismic vibrators, air-guns, seismic receivers working as sources, explosions (on the surface, in the well, in water, etc), various acoustic transmitters used in a borehole, can all be used.

The seismic source(s) can be located at the surface, in the sea water and/or in a borehole.

One or several seismic sources can be applied to generate various shapes and amplitudes of the wave pulse(s) at the depth of the region of interest.

As shown in FIG. 3, in the case of reservoir-scale stimulation, the wave pulses can be applied from a low frequency (e.g. 1-200 Hz) vibrational source 8a (e.g. a seismic vibrator) located at the surface. Such wave pulses are directed to travel down to the region of interest 9. Alternatively, pressure pulsing technology such as borehole fluid injections can be used to apply the wave pulses.

In the case of near-wellbore-scale stimulation, the wave pulses can be applied with a high frequency (1-100 kHz) acoustic source 8b placed in the wellbore.

Typical amplitudes of the seismic waves are very small, with strain amplitudes of 10⁻⁶ to 10⁻⁸, which correspond to stress amplitudes of 10⁴ Pa to 10² Pa, for a rock with a Young's modulus of ˜10 GPa. Wave pulses require significantly lower wave amplitudes than the amplitude that would be required for a comparable effect with a continuous wave.

In some embodiments, a number of seismic sources are used to emit the wave pulses for stimulating hydrocarbon production in order to maximise the effect of seismic vibration. The model can predict how many sources of a given vibrational power should be applied in order to have a non-negligible effect on oil recovery.

At step 4, hydrocarbons are extracted from the region of interest 9, e.g. via a well 7 as shown in FIG. 3, in a standard manner. Step 4 is performed at the same time as step 3, and step 3 is performed for as long as step 4 is performed. Seismic wave pulsing is cheap and does not harm the environment so performing step 3 for as long as step 4 is performed is not unduly problematic.

The above method of stimulating hydrocarbon production can be performed in various locations including offshore, onshore, and in producing boreholes.

Offshore hydrocarbon production can be stimulated by seismic vessels or by seabed equipment used for permanent reservoir monitoring or by air gun sources.

Onshore hydrocarbon production can be stimulated by seismic vibrators.

Hydrocarbon production in producing wells can be stimulated by acoustic sources, e.g. permanently installed in the borehole.

In some cases, air guns or other explosive sources may not be suitable as they produce predominantly compressional wave pulses (i.e. of a single polarity), which, in some regions, may result in a decrease in relative oil permeability. Thus, in some cases, sources other than air guns or other explosive sources may be required, e.g., if a wave pulse with opposite (extensional, not compressional) polarity is required to increase relative oil permeability. This can be determined by the model.

### REFERENCES

Beresnev, I. A. and Johnson, P. A., 1994. Elastic-wave stimulation of oil production: A review of methods and results. Geophysics, 59(6), pp. 1000-1017.
Manga, M., Beresnev, L, Brodsky, E. E., Elkhouy, J. E., Elsworth, D., Ingebritsen, S. E., Mays, D. C. and Wang, C. Y., 2012. Changes in permeability caused by transient stresses: Field observations, experiments, and mechanisms. Reviews of Geophysics, 50(2).
Rozhko, A. Y., 2016. Two-phase fluid-flow modeling in a dilatant crack-like pathway. Journal of Petroleum Science and Engineering, 146, 1158-1172.
Rozhko, A. Y., and Bauer A., 2018. Contact line friction and surface tension effects on seismic attenuation and effective bulk moduli in rock with a partially saturated crack. Geophysical Prospecting.
Ruiz-Cabello, F. M., Rodriguez-Valverde, M. A., & Cabrerizo-Vilchez, M. A. (2014). Equilibrium contact angle or the most-stable contact angle?. Advances in colloid and interface science. 206, 320-327.

1. A method of predicting which shape and/or amplitude of seismic wave or wave pulse would cause an increase in oil relative permeability, or a decrease in water relative permeability, when a seismic wave or wave pulse with that shape and/or amplitude is applied to a region of interest, the method comprising:
a. obtaining one or more parameter values for the region of interest;
b. inputting the one or more parameter values into a model which predicts changes in oil and/or water relative permeability for the region of interest for different seismic wave or wave pulse shapes and/or amplitudes;
c. repeating step b one or more times for different seismic wave or wave pulse shapes and/or amplitudes; and
d. determining which seismic wave or wave pulse shape and/or amplitude would cause an increase or the greatest increase in oil relative permeability, and/or a decrease or the greatest decrease in water relative permeability, based on the output of the model.

2. The method as claimed in claim 1, wherein the model is based on wave-induced two-phase fluid-flow and/or the contact angle hysteresis effect.

3. The method as claimed in claim 1, wherein the parameter values comprise one or more of: the Young's modulus, Poisson's ratio, crack length, initial aspect ratio, Skempton's coefficients for oil and/or water phases, oil-water interface tension, advancing and receding contact angles or wettability, and minimum effective stress.

4. The method as claimed in claim 1, wherein the different seismic wave or wave pulse shapes and/or amplitudes comprise seismic wave or wave pulses with varying polarity and/or amplitude.

5. The method as claimed in claim 4, wherein step d comprises determining which seismic wave or wave pulse polarity and/or amplitude causes an increase or the greatest increase in oil relative permeability, and/or a decrease or the greatest decrease in water relative permeability, based on the output of the model.

6. The method as claimed in claim 1, wherein the different seismic wave or wave pulse shapes and/or amplitudes comprise wave pulse shapes and/or amplitudes.

7. The method as claimed in claim 6, wherein determining which seismic wave pulse shape causes the greatest increase in oil relative permeability, and/or a decrease or the greatest decrease in water relative permeability, based on the output of the model comprises determining which polarity wave pulse shape would cause the greatest increase in oil relative permeability, and/or a decrease or the greatest decrease in water relative permeability, based on the output of the model.

8. The method as claimed in claim 1, wherein the method is performed on a computer and the method comprises displaying a result of the method on a screen.

9. A method of stimulating hydrocarbon production comprising:
a. predicting which shape and/or amplitude of seismic wave or wave pulse would cause an increase or the greatest increase in oil relative permeability, and/or a decrease or the greatest decrease in water relative permeability, when a seismic wave or wave pulse with that shape and/or amplitude is applied to a region of interest; and
b. applying a seismic wave or wave pulse with the predicted shape and/or amplitude to the region of interest thereby stimulating hydrocarbon production.

10. The method as claimed in claim 9, further comprising recovering hydrocarbons from the region of interest.

11. The method as claimed in claim 9, wherein step a comprises performing the method of claim 1.

12. A method of stimulating hydrocarbon production comprising applying a seismic wave pulse to a region of interest to increase oil relative permeability, and/or decrease water relative permeability, for the region of interest and thereby stimulate hydrocarbon production.

13. The method as claimed in claim 12, further comprising performing the method of any of claim 1 in order to determine a shape and/or amplitude of the seismic wave pulse applied.

14. The method as claimed in claim 12, further comprising recovering hydrocarbons from the region of interest.

15. A system for stimulating hydrocarbon production comprising:
at least one seismic source; and
means for predicting which shape and/or amplitude of seismic wave or wave pulse would cause an increase or the greatest increase in oil relative permeability, and/or a decrease or the greatest decrease in water relative permeability, when a seismic wave or wave pulse with that shape and/or amplitude is applied to a region of interest;
wherein the system is arranged such that the at least one seismic source can be controlled to emit seismic waves or wave pulses with a shape and/or amplitude determined by the means for predicting which shape and/or amplitude of seismic wave or wave pulse would cause an increase or the greatest increase in oil relative permeability, and/or a decrease or the greatest decrease in water relative permeability, when a seismic wave or wave pulse with that shape and/or amplitude is applied to a region of interest.

16. The system as claimed in claim 15, wherein the at least one seismic source is arranged to emit seismic wave pulses.

17. The system as claimed in claim 16, wherein the seismic wave pulses can have positive or negative polarity.

18. The system as claimed in claim 15, wherein the means for predicting which shape and/or amplitude of seismic wave or wave pulse would cause an increase or the greatest increase in oil relative permeability, and/or a decrease or the greatest decrease in water relative permeability, when a seismic wave or wave pulse with that shape and/or amplitude is applied to a region of interest is arranged to perform the method of claim 1.

19. The system as claimed in claim 15, wherein the means for predicting which shape and/or amplitude of seismic wave or wave pulse would cause an increase or the greatest increase in oil relative permeability, and/or a decrease or the greatest decrease in water relative permeability, when a seismic wave or wave pulse with that shape and/or amplitude is applied to a region of interest comprises one or more processors arranged to predict which shape and/or amplitude of seismic wave or wave pulse would cause an increase in oil relative permeability, and/or a decrease in water relative permeability, when a seismic wave or wave pulse with that shape and/or amplitude is applied to a region of interest.

20. The system as claimed in claim 15, comprising a controller arranged to cause the at least one seismic source to emit a seismic wave or wave pulse with a shape and/or amplitude for increasing oil relative permeability, and/or decreasing water relative permeability, based on an output of the means for predicting which shape and/or amplitude of seismic wave or wave pulse would cause an increase or the greatest increase in oil relative permeability, and/or a decrease or the greatest decrease in water relative permeability, when a seismic wave or wave pulse with that shape and/or amplitude is applied to a region of interest.
